(19) United States
(12) Patent Application Publication
(10) Pub. No.: US 2013/0227476 A1
(43) Pub. Date: Aug. 29, 2013

(54) METHOD, APPARATUS AND COMPUTER PROGRAM PRODUCT FOR MANAGEMENT OF INFORMATION ON A GRAPHIC USER INTERFACE

(71) Applicant: Sebastian Frey, Woodland Hills, CA (US)

(72) Inventor: Sebastian Frey, Woodland Hills, CA (US)

(73) Assignee: NOKIA CORPORATION, Espoo (FI)

(21) Appl. No.: 13/404,146

(22) Filed: Feb. 24, 2012

(51) Int. Cl. G06F 3/048

(52) U.S. Cl. 715/810

(57) ABSTRACT

Provided herein are a method, apparatus and computer program product for arranging and re-arranging information presented on a display. In particular, methods may include providing for display of a plurality of tiles, each in a respective first location; receiving an input proximate a first point on a display; and moving at least one of the plurality of tiles toward the first point in response to receiving the input proximate the first point. The tiles may include representations of applications, data, or information. The plurality of tiles may include tiles related to a first group and tiles related to a second group, where moving at least one of the plurality of tiles toward the first point may include moving the tiles related to the first group toward the first point while the tiles related to the second group remain in their respective first locations.

### TECHNOLOGICAL FIELD

Example embodiments of the present invention relate generally to the presentation of information on a display, and more particularly, to a method of arranging a plurality tiles on a display in response to an input.

### BACKGROUND

The modern communications era has brought about a tremendous expansion of wireline and wireless networks. Computer networks, television networks, and telephone networks are experiencing an unprecedented technological expansion, fueled by consumer demand. Wireless and mobile networking technologies have addressed consumer demands while providing more flexibility and immediacy of information transfer.

Mobile devices, such as cellular telephones, have become smaller and lighter while also becoming more capable of performing tasks that far exceed a traditional voice call. Mobile devices are becoming small, portable computing devices that are capable of running a variety of applications, some of which benefit from a larger display. These devices are comparable in capabilities to laptop or desktop-type computers such that they can execute thousands of available applications. The portability of such devices may be enhanced by reducing their size, and hence, their display size. With limited display capability, only a select number of applications or tiles representing applications or other information may be displayed at any given time. Therefore, optimization of the display area and management of information presented on the display, including the arrangement of displayed items, may be desirable to enhance the user experience.

### SUMMARY

In general, an example embodiment of the present invention provides an improved method of arranging and re-arranging information presented on a display. In particular, the method of example embodiments may include providing for display of a plurality of tiles, each in a respective first location; receiving an input proximate a first point on a display; and moving at least one of the plurality of tiles toward the first point in response to receiving the input proximate the first point. The tiles may include representations of applications, data, or information. The plurality of tiles may include tiles related to a first group and tiles related to a second group, where moving at least one of the plurality of tiles toward the first point may include moving the tiles related to the first group toward the first point while the tiles related to the second group remain in their respective first locations. Optionally, the second group of tiles may be re-arranged proximate their respective first locations.

Methods according to example embodiments may further include arranging the at least one of the plurality of tiles around the first point. Methods may also optionally include returning the at least one of the plurality of tiles to their respective first locations in response to a predetermined amount of time elapsing and/or returning the at least one of the plurality of tiles to their respective first locations in response to a second input.

Example embodiments of the invention may provide an apparatus including at least one processor and at least one memory including computer program code. The at least one memory and the computer program code configured to, with the at least one processor, cause the apparatus to provide for display of a plurality of tiles, each in a respective first location; receive an input proximate a first point of a display; and move at least one of the plurality of tiles toward the first point in response to receiving the input proximate the first point. The tiles may include representations of applications, data, or information. The plurality of tiles may include tiles related to a first group and tiles related to a second group, where moving at least one of the plurality of tiles toward the first point may include moving the tiles related to the first group toward the first point while the tiles related to the second group remain in their respective first locations. Moving at least one of the plurality of tiles toward the first point may include moving the tiles related to the first group toward the first point and re-arranging the tiles related to the second group proximate their respective first locations.

An apparatus according to embodiments of the present invention may be caused to arrange the at least one of the plurality of tiles around the first point. The apparatus may optionally be caused to return the at least one of the plurality of tiles to their respective first locations in response to a predetermined amount of time elapsing and/or returning the at least one of the plurality of tiles to their respective first locations in response to a second input.

Embodiments of the present invention may provide a computer program product including at least one non-transitory, computer-readable storage medium having computer executable program code instructions stored therein. The computer executable program code instructions may include program code instructions for providing for display of a plurality of tiles, each in a respective first location; program code instructions for receiving an input proximate a first point of a display; and program code instructions for moving at least one of the plurality of tiles toward the first point in response to receiving the input proximate the first point. The tiles may include representations of applications, data, or information. The plurality of tiles may include tiles related to a first group and tiles related to a second group, where the program code instructions for moving at least one of the plurality of tiles toward the first point may include program code instructions for moving the tiles related to the first group toward the first point while the tiles related to the second group remain in their respective first location. The program code instructions for moving at least one of the plurality of tiles toward the first point may include program code instructions for moving the tiles related to the first group toward the first point and program code instructions for re-arranging the tiles related to the second group proximate their respective first locations.

Computer program products according to example embodiments of the present invention may include program code instructions for arranging the at least one of the plurality of tiles around the first point. Example computer program products may further include program code instructions for returning the at least one of the plurality of tiles to their respective first locations in response to a predetermined amount of time elapsing and/or program code instructions for returning the at least one of the plurality of tiles to their respective first locations in response to a second input.

Example embodiments of the invention may provide an apparatus including means for providing for display of a plurality of tiles, each in a respective first location; means for receiving an input proximate a first point of a display; and means for moving at least one of the plurality of tiles toward the first point in response to receiving the input proximate the first point. The tiles may include representations of applications, data, or information. The plurality of tiles may include tiles related to a first group and tiles related to a second group, where the means for moving at least one of the plurality of tiles toward the first point may include means for moving the tiles related to the first group toward the first point while the tiles related to the second group remain in their respective first locations. The means for moving at least one of the plurality of tiles toward the first point may include means for moving the tiles related to the first group toward the first point and means for re-arranging the tiles related to the second group proximate their respective first locations.

An apparatus according to embodiments of the present invention may include means for arranging the at least one of the plurality of tiles around the first point. The apparatus may optionally include means for returning the at least one of the plurality of tiles to their respective first locations in response to a predetermined amount of time elapsing and/or means for returning the at least one of the plurality of tiles to their respective first locations in response to a second input.

### DRAWING(S)

Having thus described embodiments of the invention in general terms, reference will now be made to the accompanying drawings, which are not necessarily drawn to scale, and wherein:

FIG. 1 is a schematic block diagram of a mobile terminal according to an example embodiment of the present invention;

FIG. 2 is a schematic block diagram of an apparatus for providing a mechanism by which a plurality of tiles may be rearranged on a display according to an example embodiment of the present invention;

FIG. 3 is an illustration of a device displaying a plurality of tiles;

FIG. 4 is an illustration of a device displaying a plurality of tiles including tiles representing application with full functionality and applications with partial functionality;

FIG. 5 is an illustration of a device presenting a plurality of tiles rearranged to better display an application according to an example embodiment of the present invention;

FIG. 6 is an illustration of a device receiving an input proximate a first point according to an example embodiment of the present invention;

FIG. 7 is an illustration of a device displaying a plurality of tiles rearranged in response to an input according to an example embodiment of the present invention;

FIG. 8 is an illustration of a device displaying a plurality of tiles rearranged in response to an input according to another example embodiment of the present invention;

FIG. 9 is an illustration of a device displaying a plurality of tiles rearranged in response to an input according to another example embodiment of the present invention;

FIG. 10 is an illustration of a device displaying a plurality of tiles rearranged in response to an number of inputs according to an example embodiment of the present invention;

FIG. 11 is an illustration of a device displaying a plurality of tiles rearranged in response to an input according to another example embodiment of the present invention;

FIG. 12 is an illustration of a device displaying a plurality of tiles rearranged in response to two inputs according to another example embodiment of the present invention; and

FIG. 13 is a flowchart of a method for management of information on a graphic user interface according to an example embodiment of the present invention.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with some embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein a “computer-readable storage medium,” which refers to a non-transitory, physical storage medium (e.g., volatile or non-volatile memory device), can be differentiated from a “computer-readable transmission medium,” which refers to an electromagnetic signal.

Devices that may benefit from example embodiments of the present invention may include portable devices, such as tablet computers, cellular telephones, portable media devices, or the like, which are enhanced by a graphical user interface presented on a display, such as a touch screen. As portability of these devices often relates to their size, a smaller size may enhance portability while potentially sacrificing the available display area. Therefore it may be desirable to optimize the display to present, organize, and rearrange as much information as possible in an easily intelligible manner. Further, as these devices may be capable of displaying large amounts of information of various types and forms, it may be beneficial to have a mechanism by which objects on the display are moved, temporarily or otherwise, to permit unobstructed viewing of displayed information.

Some embodiments of the present invention may relate to a provision of a mechanism by which the user interface is enhanced by enabling a user to quickly and easily move and reorganize or rearrange objects on a display. Example embodiments may include presenting a list of applications or plurality of tiles representing applications, data, or information to a user. It may be desirable for a user to rearrange the plurality of tiles in response to an input to better view other objects on the display.

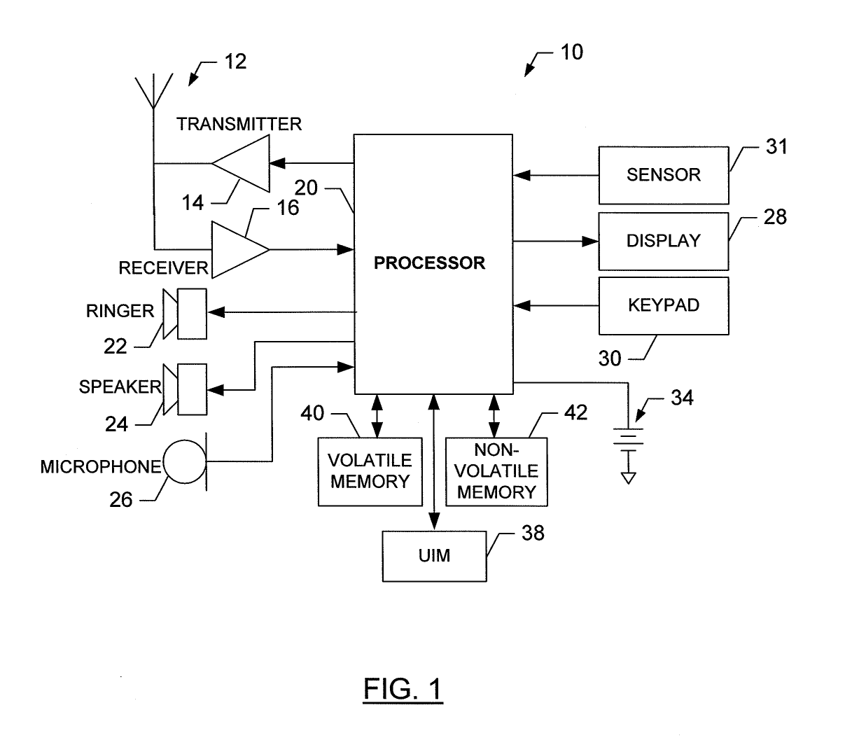

One example embodiment of the invention is depicted in FIG. 1 which illustrates a block diagram of a mobile terminal 10 that would benefit from embodiments of the present invention. It should be understood, however, that the mobile terminal 10 as illustrated and hereinafter described is merely illustrative of one type of device that may benefit from embodiments of the present invention and, therefore, should not be taken to limit the scope of embodiments of the present invention. As such, although numerous types of mobile terminals, such as personal digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other devices including fixed (non-mobile) electronic devices may also employ some example embodiments.

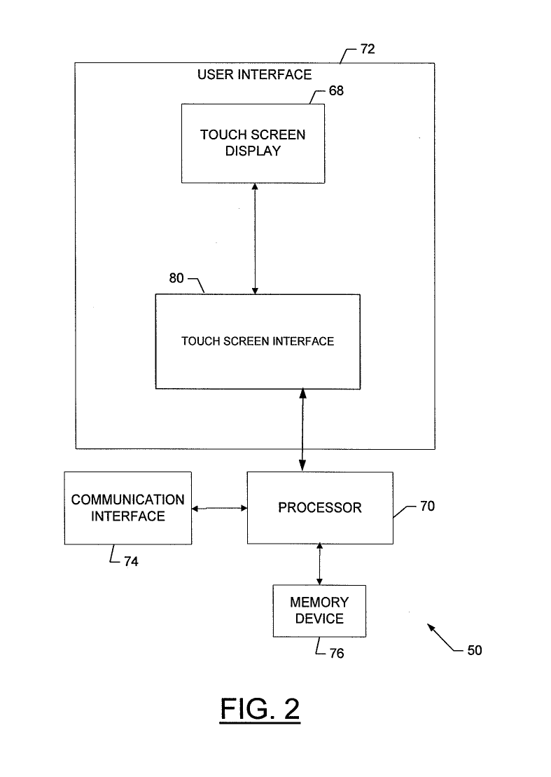

The mobile terminal 10 may include an antenna 12 (or multiple antennas) in operable communication with a transmitter 14 and a receiver 16. The mobile terminal 10 may further include an apparatus, such as a processor 20 or other processing device (e.g., processor 70 of FIG. 2), which controls the provision of signals to and the receipt of signals from the transmitter 14 and receiver 16, respectively. The signals may include signaling information in accordance with the air interface standard of the applicable cellular system, and also user speech, received data and/or user generated data. In this regard, the mobile terminal 10 is capable of operating with one or more air interface standards, communication protocols, modulation types, and access types. By way of illustration, the mobile terminal 10 is capable of operating in accordance with any of a number of first, second, third and/or fourth-generation communication protocols or the like. For example, the mobile terminal 10 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 10 may be capable of operating in accordance with non-cellular communication mechanisms. For example, the mobile terminal 10 may be capable of communication in a wireless local area network (WLAN) or other communication networks.

In some embodiments, the processor 20 may include circuitry desirable for implementing audio and logic functions of the mobile terminal 10. For example, the processor 20 may be comprised of a digital signal processor device, a microprocessor device, and various analog to digital converters, digital to analog converters, and other support circuits. Control and signal processing functions of the mobile terminal 10 are allocated between these devices according to their respective capabilities. The processor 20 thus may also include the functionality to convolutionally encode and interleave message and data prior to modulation and transmission. The processor 20 may additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the mobile terminal 10 to transmit and receive Web content, such as location-based content and/or other web page content, according to a Wireless Application Protocol (WAP), Hypertext Transfer Protocol (HTTP) and/or the like, for example.

The mobile terminal 10 may also comprise a user interface including an output device such as a conventional earphone or speaker 24, a ringer 22, a microphone 26, a display 28, and a user input interface, all of which are coupled to the processor 20. The user input interface, which allows the mobile terminal 10 to receive data, may include any of a number of devices allowing the mobile terminal 10 to receive data, such as a keypad 30, a touch display (display 28 providing an example of such a touch display) or other input device. In embodiments including the keypad 30, the keypad 30 may include the conventional numeric (0-9) and related keys (#, *), and other hard and soft keys used for operating the mobile terminal 10. Alternatively or additionally, the keypad 30 may include a conventional QWERTY keypad arrangement. The keypad 30 may also include various soft keys with associated functions. In addition, or alternatively, the mobile terminal 10 may include an interface device such as a joystick or other user input interface. Some embodiments employing a touch display may omit the keypad 30 and any or all of the speaker 24, ringer 22, and microphone 26 entirely. Additional input to the processor 20 may include a sensor 31.The sensor 31 may include one or more of a motion sensor, temperature sensor, light sensor, accelerometer, or the like. Forms of input that may be received by the sensor may include physical motion of the mobile terminal 10, whether or not the mobile terminal 10 is in a dark environment (e.g., a pocket) or in daylight, whether the mobile terminal is being held by a user or not (e.g., through temperature sensing of a hand). The mobile terminal 10 further includes a battery 34, such as a vibrating battery pack, for powering various circuits that are required to operate the mobile terminal 10, as well as optionally providing mechanical vibration as a detectable output.

The mobile terminal 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the mobile terminal 10 may be equipped with memory. For example, the mobile terminal 10 may include volatile memory 40, such as volatile Random Access Memory (RAM) including a cache area for the temporary storage of data. The mobile terminal 10 may also include other non-volatile memory 42, which may be embedded and/or may be removable. The memories may store any of a number of pieces of information, and data, used by the mobile terminal 10 to implement the functions of the mobile terminal 10.

An example embodiment of the present invention will now be described with reference to FIG. 2, in which certain elements of an apparatus 50 for managing information presented on a graphical user interface are illustrated. The apparatus 50 of FIG. 2 may be a device such as mobile terminal 10 of FIG. 1. However, it should be noted that the present invention may be embodied on any number of devices that include, or are otherwise in communication with displays.

The apparatus 50 may, in some embodiments, be a mobile terminal (e.g., mobile terminal 10) as illustrated in FIG. 1 or a computing device configured to employ an example embodiment of the present invention. However, in some embodiments, the apparatus 50 may be embodied as a chip or chip set. In other words, the apparatus 50 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 50 may therefore, in some cases, be configured to implement an embodiment of the present invention on a single chip or as a single “system on a chip.” As such, in some cases, a chip or chipset may constitute means for performing one or more operations for providing the functionalities described herein.

The processor 70 may be embodied in a number of different ways. For example, the processor 70 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 70 may include one or more processing cores configured to perform independently. A multi-core processor may enable multiprocessing within a single physical package. Additionally or alternatively, the processor 70 may include one or more processors configured in tandem via the bus to enable independent execution of instructions, pipelining and/or multithreading.

In an example embodiment, the processor 70 may be configured to execute instructions stored in the memory device 76 or otherwise accessible to the processor 70. Alternatively or additionally, the processor 70 may be configured to execute hard coded functionality. As such, whether configured by hardware or software methods, or by a combination thereof, the processor 70 may represent an entity (e.g., physically embodied in circuitry) capable of performing operations according to an embodiment of the present invention while configured accordingly. Thus, for example, when the processor 70 is embodied as an ASIC, FPGA or the like, the processor 70 may be specifically configured hardware for conducting the operations described herein. Alternatively, as another example, when the processor 70 is embodied as an executor of software instructions, the instructions may specifically configure the processor 70 to perform the algorithms and/or operations described herein when the instructions are executed. However, in some cases, the processor 70 may be a processor of a specific device (e.g., a mobile terminal or network device) adapted for employing an embodiment of the present invention by further configuration of the processor 70 by instructions for performing the algorithms and/or operations described herein. The processor 70 may include, among other things, a clock, an arithmetic logic unit (ALU) and logic gates configured to support operation of the processor 70.

Meanwhile, the communication interface 74 may be any means such as a device or circuitry embodied in either hardware or a combination of hardware and software that is configured to receive and/or transmit data from/to a network and/or any other device or module in communication with the apparatus 50. In this regard, the communication interface 74 may include, for example, an antenna (or multiple antennas) and supporting hardware and/or software for enabling communications with a wireless communication network. In some environments, the communication interface 74 may alternatively or also support wired communication. As such, for example, the communication interface 74 may include a communication modem and/or other hardware/software for supporting communication via cable, digital subscriber line (DSL), universal serial bus (USB) or other mechanisms.

The user interface 72 may be in communication with the processor 70 to receive an indication of a user input at the user interface 72 and/or to provide an audible, visual, mechanical or other output to the user. As such, the user interface 72 may include, for example, a keyboard, a mouse, a joystick, a display, a touch screen(s), touch areas, device surfaces and/or sensors capable of detecting objects hovering over the surface, soft keys, a microphone, a speaker, motion sensor, temperature sensor, accelerometer, or other input/output mechanisms. In this regard, for example, the processor 70 may comprise user interface circuitry configured to control at least some functions of one or more elements of the user interface, such as, for example, a speaker, ringer, microphone, display, and/or the like. The processor 70 and/or user interface circuitry comprising the processor 70 may be configured to control one or more functions of one or more elements of the user interface through computer program instructions (e.g., software and/or firmware) stored on a memory accessible to the processor 70 (e.g., memory device 76, and/or the like).

In an example embodiment, the apparatus 50 may include or otherwise be in communication with a display, such as the illustrated touch screen display 68 (e.g., the display 28). In different example cases, the touch screen display 68 may be a two dimensional (2D) or three dimensional (3D) display. The touch screen display 68 may be embodied as any known touch screen display. Thus, for example, the touch screen display 68 could be configured to enable touch recognition by any suitable technique, such as resistive, capacitive, infrared, strain gauge, surface wave, optical imaging, dispersive signal technology, acoustic pulse recognition, etc. techniques. The user interface 72 may be in communication with the touch screen display 68 to receive indications of user inputs at the touch screen display 68 and to modify a response to such indications based on corresponding user actions that may be inferred or otherwise determined responsive to the indications. In one alternative, a touch input may be provided other than by direct interaction with a display (e.g., in cases where the user interface is projected onto a wall with a projector, or where a cursor is used to direct input on the display).

In an example embodiment, the apparatus 50 may include a touch screen interface 80. The touch screen interface 80 may, in some instances, be a portion of the user interface 72. However, in some alternative embodiments, the touch screen interface 80 may be embodied as the processor 70 or may be a separate entity controlled by the processor 70. As such, in some embodiments, the processor 70 may be said to cause, direct or control the execution or occurrence of the various functions attributed to the touch screen interface 80 (and any components of the touch screen interface 80) as described herein. The touch screen interface 80 may be any means such as a device or circuitry operating in accordance with software or otherwise embodied in hardware or a combination of hardware and software (e.g., processor 70 operating under software control, the processor 70 embodied as an ASIC or FPGA specifically configured to perform the operations described herein, or a combination thereof) thereby configuring the device or circuitry to perform the corresponding functions of the touch screen interface 80 as described herein. Thus, in examples in which software is employed, a device or circuitry (e.g., the processor 70 in one example) executing the software forms the structure associated with such means.

The touch screen interface 80 may be configured to receive an indication of an input in the form of a touch event at the touch screen display 68. As such, the touch screen interface 80 may be in communication with the touch screen display 68 to receive indications of user inputs at the touch screen display 68 and to modify a response to such indications based on corresponding user actions that may be inferred or otherwise determined responsive to the indications. Following recognition of a touch event, the touch screen interface 80 may be configured to determine a classification of the touch event and provide a corresponding function based on the touch event in some situations. Optionally, a device may be configured to recognize a hovering input where a user may use a stylus or finger to hover over a tile or interactive element and the device may be configured to recognize the hovering as an input, for example, by using user interface 72.

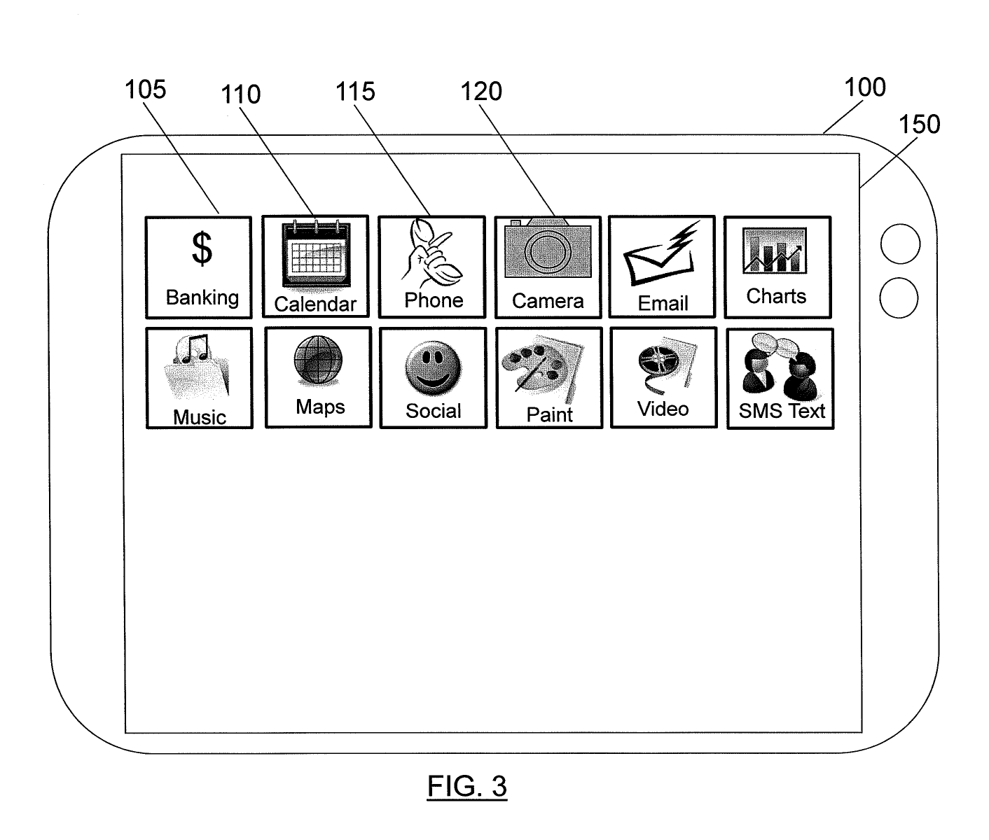

FIG. 3 depicts a device 100, such as a mobile device (e.g., mobile terminal 10), that includes a display 150 for providing a mechanism by which information displayed on a graphical user interface may be managed and organized. The display may be of any known type including touch-screen displays; however, the touch-screen functionality is not necessary to implement example embodiments of the present invention. Information may be presented on the display 150 to a user through a variety of applications and user interfaces, such as through a menu of available and/or active applications. In such an example, a list of available applications may be presented to a user through the display of a number of tiles (e.g., tiles 105, 110, 115, and 120) which may be representations of an application that provide the user an indication of which application is associated with a given tile. The depicted embodiment displays applications in a grid which may be a menu grid, home screen, or similar program showing a collection of multiple applications. While the depicted embodiment illustrates the tiles representing applications displayed in a grid, other embodiments may display the tiles in another arrangement conducive to displaying multiple tiles on the display. The tiles presented provide a user with visual representations of a plurality of available applications from which they may select.

Tiles may include images, video, icons, or any number of identifying indicia to indicate to which application they are associated. For example, a tile representing a camera application 120 may include a graphical representation of a camera, while a tile representing a banking application 105 may include a currency symbol representing the application. Optionally, the tiles may further include names or nicknames adjacent to them indicating to which application each tile is associated. Such text names may be beneficial when multiple email or music player applications are available, or when the device includes a large number of applications. Names or nicknames may also be beneficial for programs for which there is no unique tile available, such as when an application developer has not created a unique icon for an application and/or when the operating system of the device uses a common application tile. Tiles can optionally include an audio clip, video clip, or other multimedia data which may indicate to which program the tile is associated.

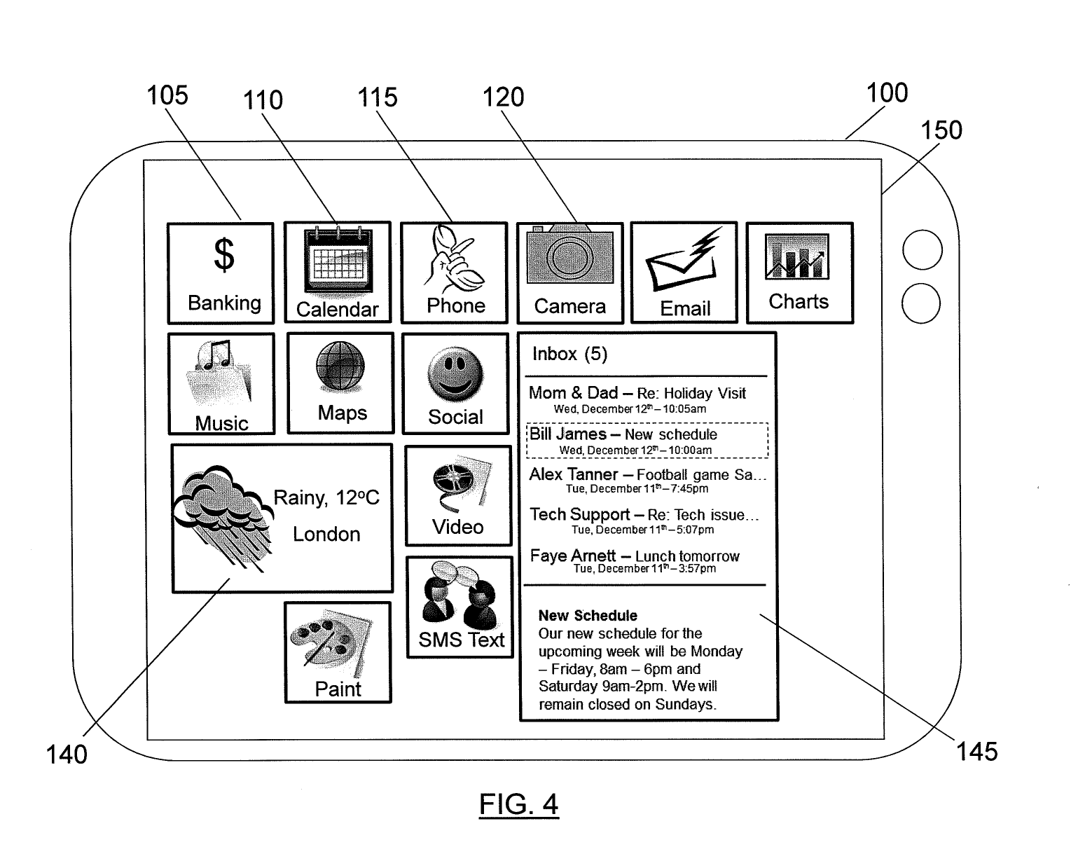

According to example embodiments of the present invention, tiles may be of a common size with one another which may be scalable to increase the number of tiles that may fit on a display 150 (e.g., smaller tiles) or to increase the detail shown with respect to each tile (e.g., larger tiles). Optionally or additionally, tiles may be of different sizes depending upon the preference of a user or the amount of information contained within a tile. Tiles may include widgets which provide a user with information pertaining to the widget, such as outside temperature for a weather application widget 140, as shown in FIG. 4. Further, tiles may include fully functioning applications shown within the tile, such as E-mail application 145. Optionally, the tiles may present partially functional applications according to further example embodiments of the present invention.

As illustrated in FIG. 4, a display 150 may become crowded with tiles representing a variety of applications. As such, it may be desirable to be able to easily manage and organize these tiles quickly and easily to enhance a user's ease of navigation through the available tiles and to improve the user's experience.

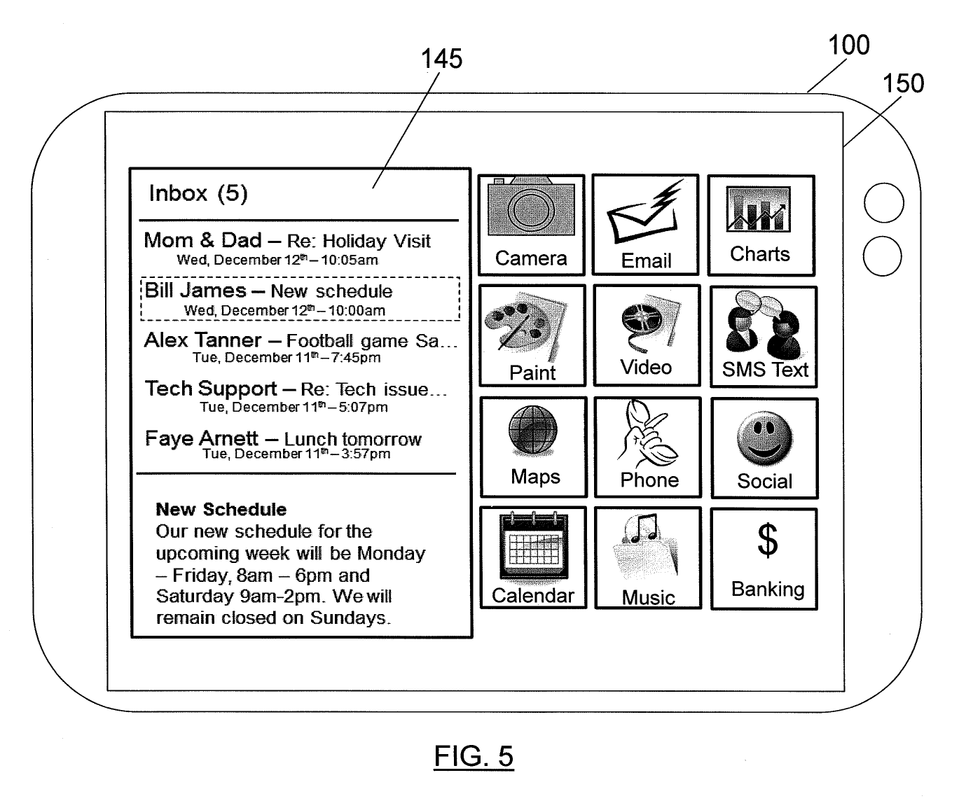

Tiles may be organized and managed automatically (e.g., by processor 20, without user input) by an operating system or application of a device implementing example embodiments of the present invention, and/or tiles may be manually manipulated and re-located on a display by a user. For example, a user may move tiles and arrange tiles on a display according to a preferred order of applications, according to groupings of similar applications, or any number of organizational preferences. Further, tiles may be moved and re-located to accommodate larger tiles or other objects a user may wish to have displayed on the display. For example, if a user wants to use a portion of the display for a particular application or to view an image behind one or more tiles, the user may re-locate each of the tiles that occupy that portion of the display. FIG. 5 illustrates the example embodiment of FIG. 3 with the tiles re-organized to be displayed along the right side of the display 150, clearing the space along the left side of the display 150 to allow the user to view the email application 145 in a larger size. Moving or rearranging the tiles may be a tedious process of dragging each tile to a new location, through an input means such as user input keypad 30 of the device 10 or the touch-screen interface 80 of apparatus 50.

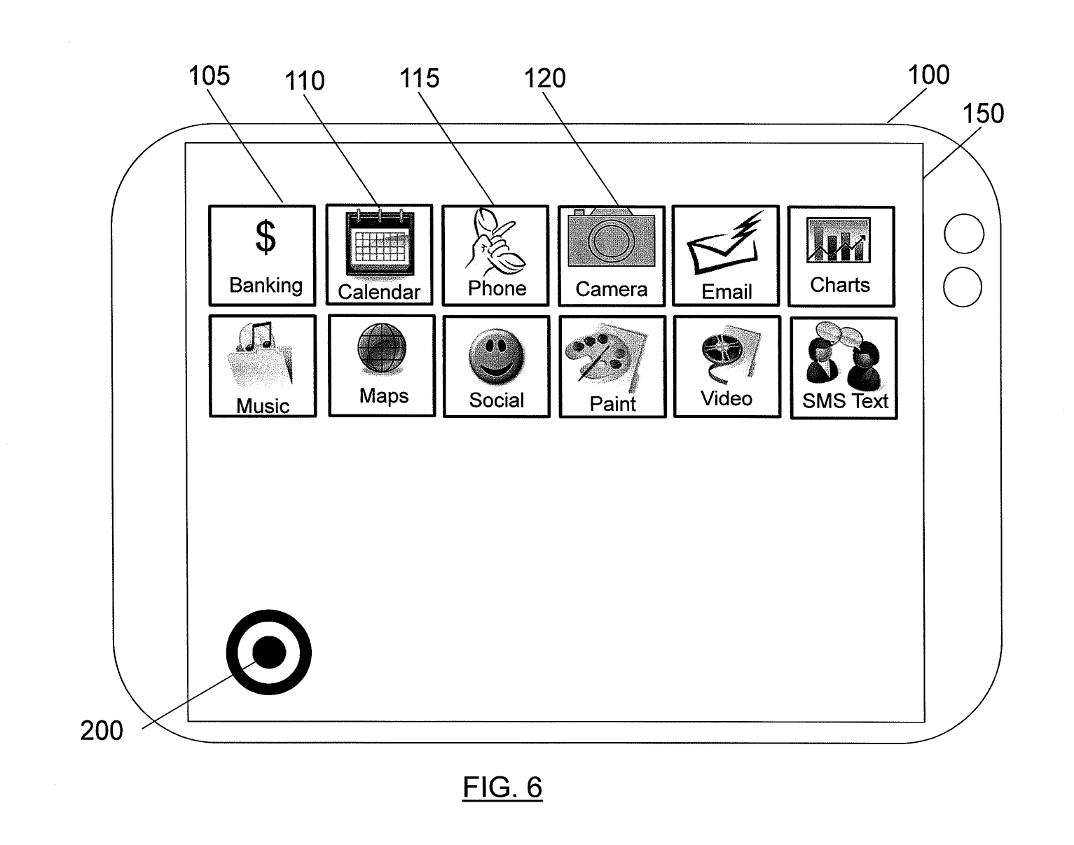

It may be desirable to more quickly and easily rearrange tiles to simplify the user interface and improve the overall user experience. FIG. 6 illustrates an example embodiment of the present invention in which a user input is received proximate a first point 200 of the display 150. The input may be in the form of a touch on a touch-screen interface (e.g., touch-screen interface 80), an indication received through a pointing device, such as a mouse, track-ball, or stylus, or the input may be of any form which indicates a point on the display 150. The input may include input parameters such as a touch duration in the embodiment of a touch-screen interface, or may be a number of taps (e.g., a double-click), for example. Examples of inputs may include a tap, a tap-and-hold, a gesture, a long press, a twisting motion with the input device, a pinch gesture, a multi-digit gesture, or any number of possible inputs available to a user. In response to the input, at least one of the tiles (e.g., tiles 105, 110, 115, and 120 among others), may be moved towards the first point. The tiles may be moved instantaneously (e.g., disappear from their original location and appear proximate the first point 200), or the tiles may move towards the first point over a duration of time (e.g., around one second). The duration of the move may be determined based upon the input received at the first point 200, it may be pre-defined (e.g., a fixed amount of time for the device), or the duration may be user configurable. The movement of the tiles from their original location to a location proximate the first point may also be non-linear, as in the tiles may appear to accelerate and decelerate as they are rearranged.

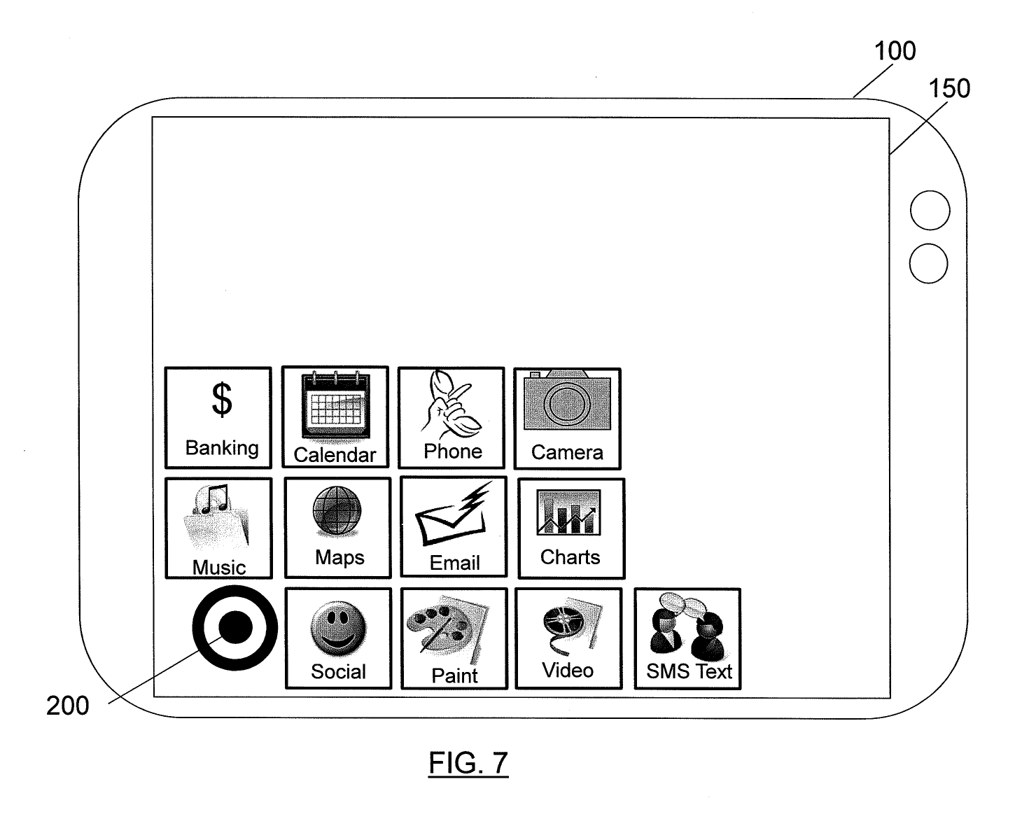

As noted above, one or more of the tiles may move towards the first point 200 in response to the input. In an example embodiment, all of the tiles on the display 150 may be moved toward the first point in response to the input. FIG. 7 illustrates the example embodiment of FIG. 6 in which all of the tiles were moved in response to the input at the first point 200. Each of the tiles moved from their first location to a second location, closer to the first point, in response to the input. While the illustrated embodiment shows no tiles moving to the first point, but rather moving to locations around the first point, other example embodiments may include where a tile may occupy the space of the first point.

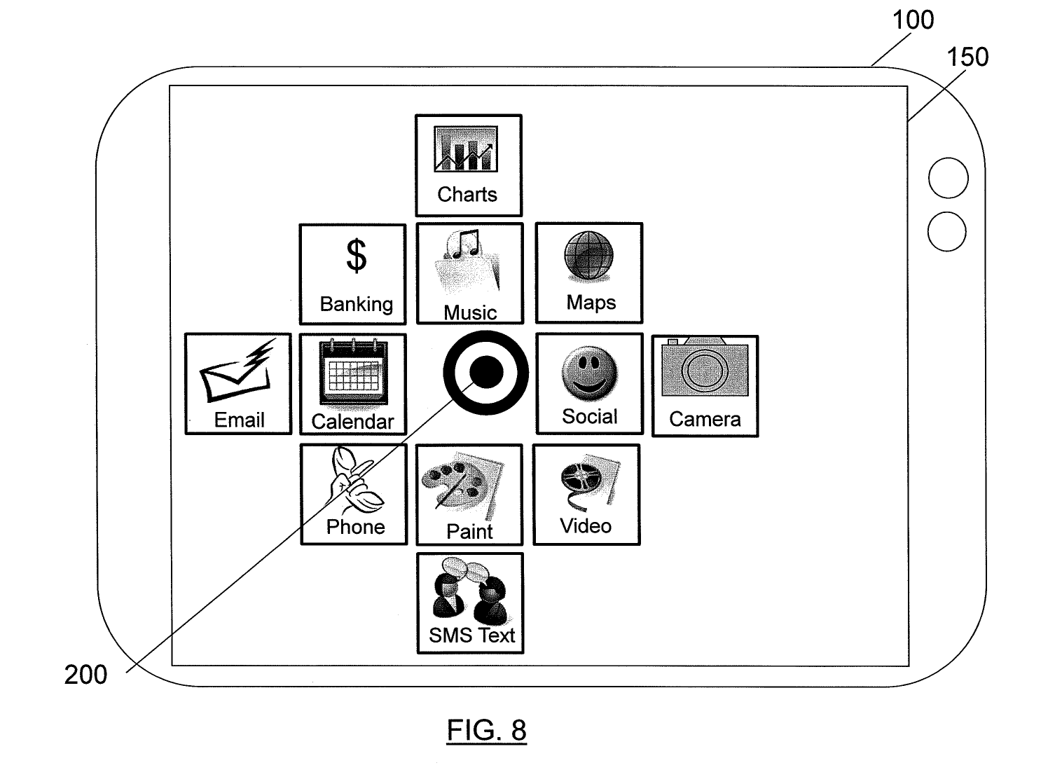

The tiles may move as if attracted to the first point 200, such as if the first point 200 were a magnet and each of the tiles were magnetically attracted to the first point. While the tiles of the embodiment of FIG. 7 re-organize as a grid, example embodiments may include where the tiles may overlap and become arranged proximate the first point 200 in a less organized manner. The tiles may obscure one another when they are moved proximate the first point 200, as may be desirable to maximize the unobstructed portion of the screen, particularly when the duration of the rearrangement (e.g., time before the tiles return to their original location) is brief or finite as will be described further below. FIG. 8 illustrates another example embodiment in which the first location is a location closer to the middle of the display, and the tiles are re-arranged around the first point.

In some embodiments, the response of rearrangement of the tiles may be contingent upon various parameters of the input. For example, an input which includes a long duration at a particular point, may cause tiles to move faster toward the point of the input or may cause more tiles (e.g., tiles that are further away) to move toward the point of the input. An input which includes a shorter duration may cause the tiles to move more slowly toward the point of the input or cause only the tiles closest to the point of the input to move toward the input. In such an example embodiment, the duration of the touch may correlate to a “magnetism” of the point such that a longer duration increases the magnetism of the point of the input and the tiles become more attracted to that point as the duration is increased.

Example embodiments may include a force sensitive touch input display in which the force of the input is a parameter of the input. In such an embodiment, a greater touch force may correlate to a greater “magnetism” of the point. Optionally, the touch may correlate to a virtual depression of the display where objects and tiles close to the input are drawn into the depression at the point of the input. A greater force of touch may correlate to a greater virtual depression, causing tiles further from the point of the input to be drawn toward the point of the input and the speed of motion increase as the tiles approach the point of the input.

Embodiments in which parameters of the input affect the rearrangement of tiles may further include wherein the input parameters affect the replacement of tiles to their original locations. For example, an input of a three second duration may cause rearrangement of the tiles for three seconds following the input. Another example may include an input of a one second duration that may cause the tiles to be rearranged temporarily and replaced automatically after a predetermined time, while an input of a two second duration may cause the tiles to be rearranged indefinitely, for example until another input is received to replace the tiles to their original location.

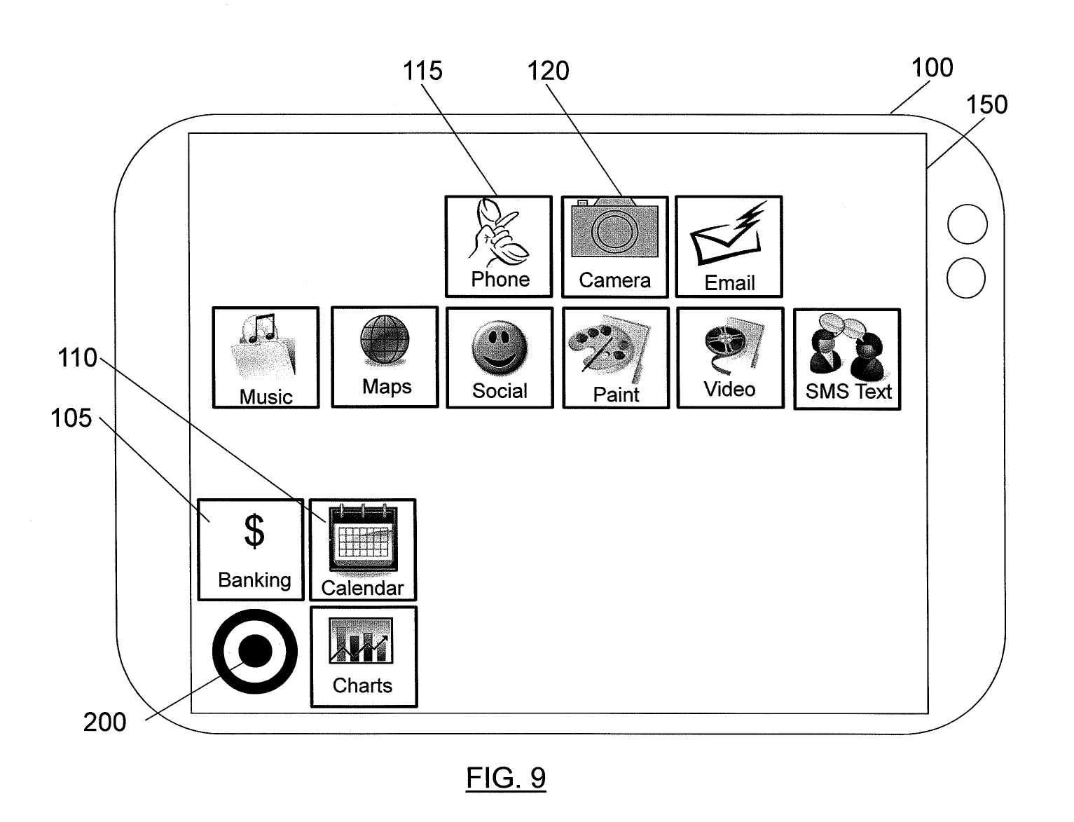

The example embodiments of FIGS. 7 and 8 depict all of the tiles of the display 150 moving proximate the first point 200 in response to the input received at the first point. However, further example embodiments may include wherein fewer than all of the tiles are moved in response to receiving the input at the first point. For example, a group of tiles may be moved and re-arranged proximate the first point 200 in response to an input. The input may be different than the input which caused all of the tiles to be moved proximate the first point. FIG. 9 illustrates an example embodiment in which a first group of tiles is moved in response to receiving the input at the first point 200. In the example embodiment of FIG. 9, a group of tiles including a tile representing a banking application, a tile representing a calendar application, and a tile representing a chart application, was moved proximate the first point 200. In the example embodiment, each of the tiles for the banking, calendar, and chart applications may have been designated as part of a particular group, such as “work applications.” In response to the input received at the first point 200, each of the work applications may be moved proximate the first point, leaving the remaining applications in their original, first locations. Such an example embodiment may be useful when differentiating games from work applications, or communications applications (e.g., SMS Text messaging, Email, Phone calls) from non-communications applications. The input received at the first point 200 may be an input specifically configured to attract applications only belonging to a certain group. For example, two long presses of a touch screen at the first point may cause all work-related applications to be attracted to the first point.

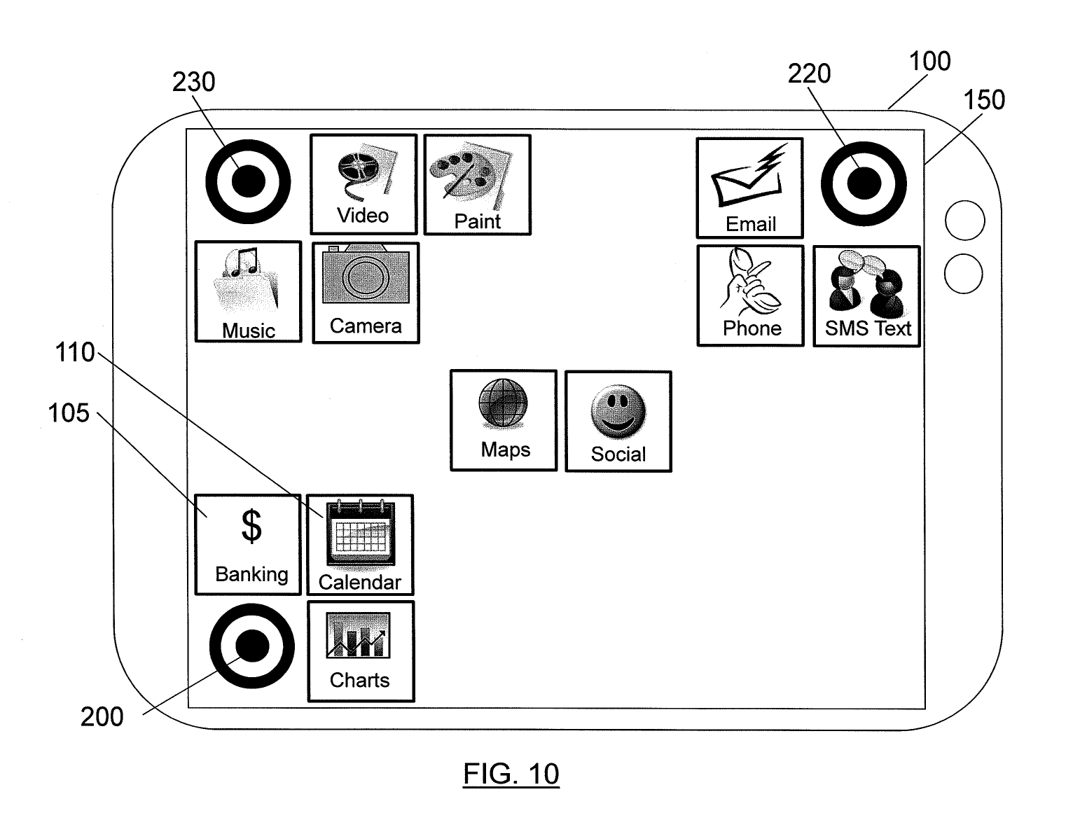

FIG. 10 illustrates an example embodiment in which three points have been indicated by three separate inputs, each comprising different input parameters (e.g., input duration, number of inputs, etc.). Each of the three separate inputs may relate to a separate group of applications. For example, the input received at the first point 200 may be related to work-related applications. The input received at the second point 220 may be related to communication-related applications, while the input received at the third point 230 may be related to multi-media-related applications. Each of the three inputs at each of the respective three points (200, 220, 230) may cause applications related thereto to be re-arranged proximate each respective point. If an application is related to more than one group (e.g., Email may be both a “work” application and a “communications” application), the first input to attract that application, or the most recent input to attract that application, may be configured to dominate the conflict. In another example embodiment, the one or more tiles in the proximity of the point of input may affect which tiles are moved. For example, if the point of input occurs near a tile that is related to a media application (such as video) other tiles related to media (such as music, camera) become attracted to the point of input and are moved within the proximity of the input. The time and intensity of the input can affect how many and/or which tiles are moved. For example, the longer the input the more tiles are moved. A visual, haptic and/or audio indication may be outputted to inform the user of the progress of the movement or when the moving operation has finished.

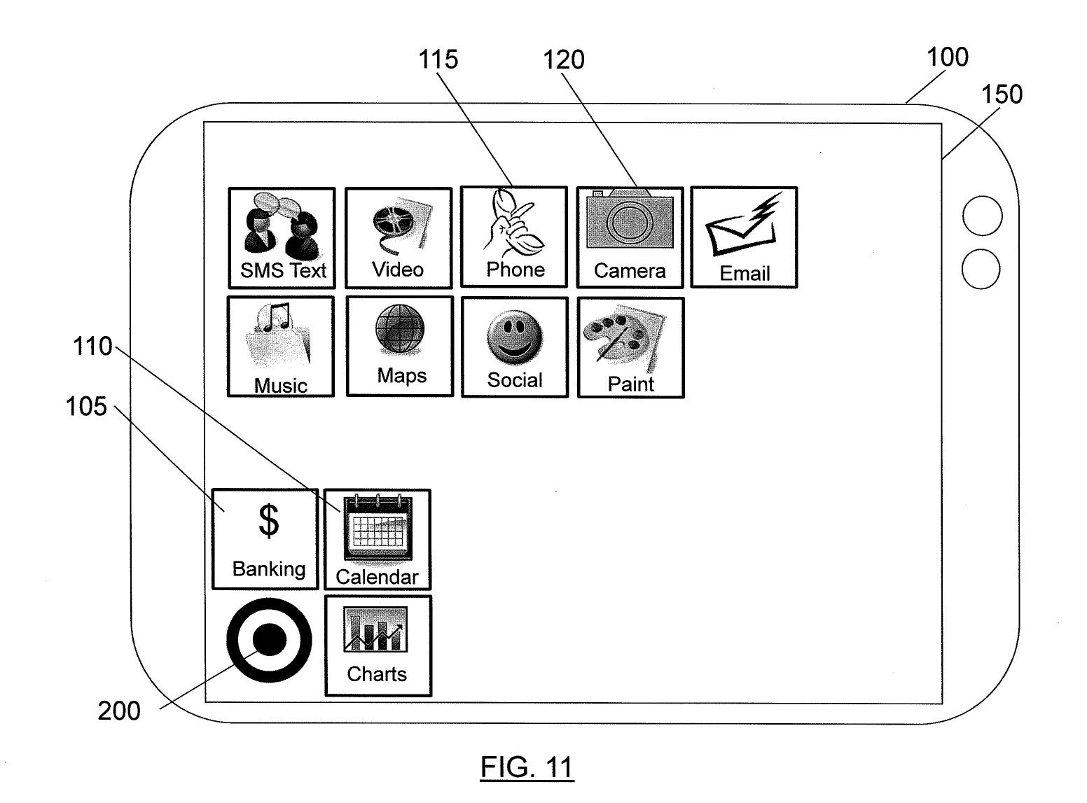

Optionally or additionally, tiles representing applications of groups which are not moved proximate to a point at which an input is received may be rearranged proximate their original locations. For example, FIG. 11 illustrates the example embodiment of FIG. 9; however, the tiles not moved proximate to the first point 200 have been rearranged according to an organization which may be directed by the device, such as by processor 20, or by a user.

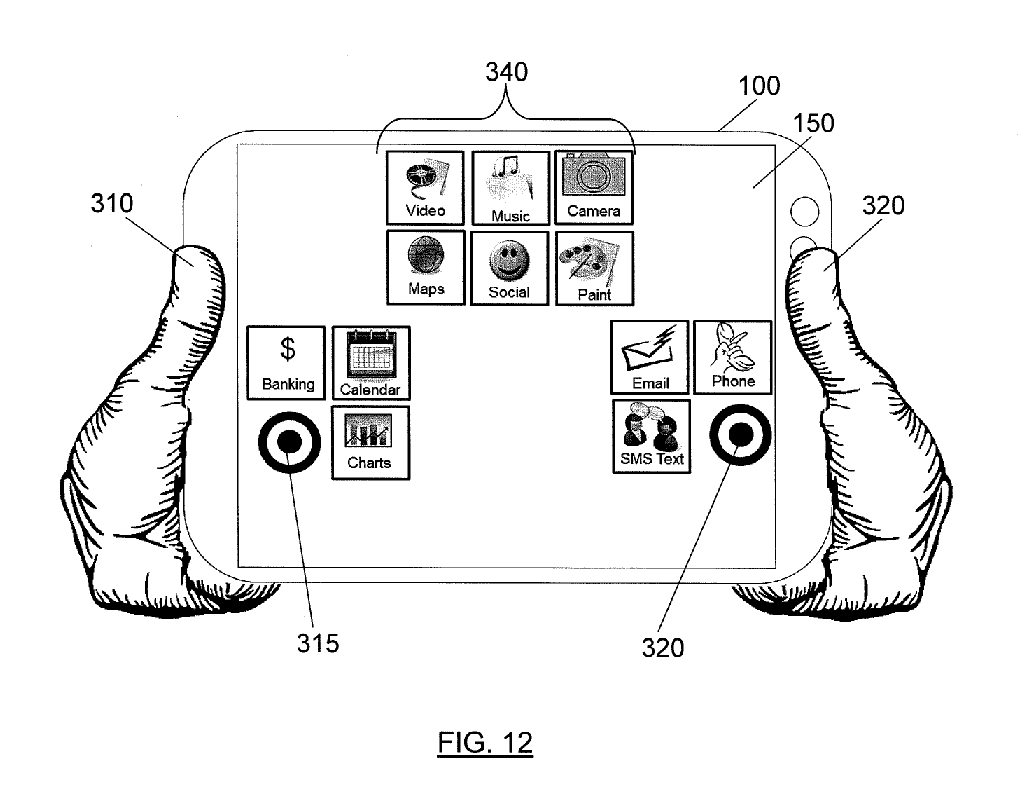

FIG. 12 illustrates an example embodiment in which a user may hold a device 100 in a comfortable or useful manner and the natural placement of their thumbs 310, 320 may be positioned proximate the sides of the display 150. While the illustrated embodiment depicts two hands and thumbs as the input device, embodiments in which a single hand may be used and/or a digit other than the thumb may also be used for input. In the illustrated embodiment, the user may touch two points of input 315, 320, each proximate a respective thumb 310, 320. The input received at each point may correlate to a particular group of tiles. For example, the input received at point 315 may correlate to business related tiles (e.g., a tile related to a banking application, a tile related to a calendar, and a tile related to a spreadsheet application) while the input received at point 325 may correlate to communications related tiles (e.g., a tile related to an email application, a tile related to making or receiving phone calls, and a tile related to a text messaging application). The tiles related to each input received at each point 315, 325, may move proximate those points for ease of access by the input device, such as the thumbs 310, 320 of the example embodiment. Further, the remaining tiles 340 not related to the input received at either point 310, 320, may be moved out of the way of the tiles that were moved proximate the points 310, 320 to provide space for those tiles. The tiles 340 may be moved proximate a point away from the input points 310, 320, or removed from the display 150 altogether.

Further example embodiments may include devices which are substantially larger than traditional hand-held devices, such as a table-top implementation in which the display may be a meter across. In such an embodiment, all sides or regions of the display may not be accessible to a user such that movement of the tiles to a position proximate the user may be desirable. In such an embodiment, the user may provide an input in a location of the display that is accessible to them to cause the tiles of the display to move proximate the point of the input.

Rearrangement of the tiles may be random, it may be based upon their original locations, or the organization may be determined by a hierarchy. The tiles that are repositioned may be repositioned according to a hierarchy or order that is determined by the user or by the device 100 itself (e.g., via processor 70). For example, a user may select their favorite programs and rank them from most important to least important. The most important programs may be represented by tiles closest to the top of the display while the least important programs are presented proximate the bottom of the display. Optionally, the device may determine (e.g., via processor 70) the most frequently used programs and maintain the most frequently used programs closest to the top of the display 105 and the last programs to be displaced.

Further example embodiments of the present invention may include hierarchies that are predictive or based upon device awareness. For example, a device according to embodiments of the present invention may include a calendar program in which a user may store scheduled meetings or appointments. A meeting or appointment scheduled within the calendar program may be scheduled as a video-conference with an agenda for the meeting attached to the appointment as a spreadsheet. The device may be configured with a first hierarchy which organizes program tiles in alphabetical order. At the time of the scheduled meeting, or a predefined amount of time before the scheduled meeting, the processor 70 of the device may be caused to switch to a second hierarchy in response to the anticipated meeting without user intervention, organizing the tiles representing programs according to those that are anticipated for use during the scheduled meeting. In the instant example, the hierarchy may present a video-conference program tile first, a spreadsheet program tile second, and subsequently list the remaining program tiles by the first hierarchy (e.g., alphabetically).

The re-organization of tiles in response to receiving an input proximate a first point may be a temporary re-organization or re-location of the tiles. For example, the tiles of FIG. 7 may be moved proximate the first point 200 and remain there for a pre-determined period of time, such as 30 seconds. This pre-determined period of time may be user-configured or application specific where the application or applications running on the device determine the pre-determined period of time. After the pre-determined period of time elapses, the tiles may return to their previous positions as shown in FIG. 6. Optionally, the tiles may remain proximate the first point 200 as shown in FIG. 7 until a second input is received indicating that the tiles are to return to their first locations as shown in FIG. 6. This second input may be the same as the first input or it may be a different input. In some example embodiments, the tiles may remain in position proximate the first point 200 as shown in FIG. 7 indefinitely, until they are moved again for rearrangement.

In example embodiments of the present invention, the tiles may be fully functional when in their original location, while being transitioned between locations, and when the tiles are re-arranged proximate a point of input on the display. The term “fully functional” when referencing a tile refers to the functions available to a user through inputs received at the tile. For example, a tile related to an application may be configured to launch the application in response to receiving an input at the tile. In such an embodiment, the application may be launched when an input is received at the tile in its original location, while the tile is being moved toward a point of an input, or when the tile has been rearranged proximate the point of an input. Tiles may provide many more available functions to a user, such as when a tile is a widget conveying information to a user. For example, a weather widget tile may be a tile that displays the current temperature and weather proximate a location of the device and the “fully functional” features of the widget may include launching of an interactive weather application, changing the location, changing the date (e.g., for weather forecasts), or other “functions” which may be available to a user through inputs received at the widget. In such an embodiment, the functionality of the tile may not differ before, during, or after movement on the display.

Example embodiments of the present invention may include tiles representing one or more of a file, folder, a clipboard item, a clipboard application, an application, and/or the like. When such tiles are attracted closer to the point of input, the user can cause an action to be performed based on manipulation of one or more of the tiles. For example, when the clipboard item and an application tile are touched upon simultaneously or in quick succession, the clipboard item may be copied to the application or its current context. When the application is a message application, the message editor may be launched with the contents of the clipboard item copied to the contents of the message. When the first tile is a file and the second tile is a folder, and the input is a drag and drop starting from the first tile and ending on the second tile, the first file may be copied to the folder. The input may be a tap, a tap-and-hold, a gesture, a long-press, and/or the like.

Embodiments of the present invention may further include replications of tiles that are moved proximate a point of an input rather than the original tile itself. In such an embodiment, if a user wishes to move a tile to a more accessible location on the display, the user may provide an input proximate a point of the display. The tile or tiles corresponding to the input (which may be some or all of the tiles) may be replicated in a semi-transparent or other embodiment which visually indicates to a user that the tiles are temporary, and moved proximate the point of the input. The temporary, moved tiles may then only be available proximate the input point for a predefined period of time or until an input is received to remove them from the display as outlined above. A haptic effect or an audio effect (e.g., a ticking sound similar to a clock) may be used to indicate to the user that the moved tiles are temporary.

The replications of tiles that are moved proximate the point of an input may be fully-functional short-cuts to the application or data to which they are associated. In an example embodiment, a user may cause an input at a point of a display that is easily accessible to the user, for example, proximate a thumb 320 of FIG. 12. The input may cause at least one tile to be replicated on the display and moved toward the point of the input. The replicated tile may be equally as functional as the original tile, which may remain in the original location on the display. The replicated tile may be presented on the display for a predetermined amount of time (e.g., 30 seconds) providing the user time to access the replicated tile in the location to which it was moved. Upon the predetermined amount of time elapsing, the replicated tile may be moved back over the original tile from which it was replicated, or the replicated tile may simply disappear.

Example embodiments of the invention have been described generally for use in a fully-interactive display; however, example embodiments of the invention may also be implemented on devices during a partially-interactive mode or a low-power mode, for example. A partially-interactive or low-power mode may correspond to a device which is operable in a limited capacity as compared with the fully-interactive capacity of the device. Such partially-interactive modes may include an airplane mode in which wireless communication services may be reduced or turned-off, a sleep-mode in which the device is using a lower amount of power to conserve available power, or a locked mode in which the device becomes fully-interactive only in response to a user unlocking the device. In such example embodiments, the movement of tiles presented on the display of the device may be available to a user as the movement may not affect any permanent changes to the device, it may not require any additional power usage (as desirable in a low-power mode), and the movement may not allow applications to be used or settings to be changed (as desirable in a locked mode).

An example embodiment of an implementation of the present invention in a partially-interactive mode may include where a device receives messages or notifications (e.g., email, SMS, social networking site updates, news feeds, device status notices, etc.) while the device is in a locked or low-power state. An input received proximate a location on the display of the device may cause the messages or notifications to be attracted to the point of the input. A user may interact with the messages or notifications (e.g., by an input such as a tap, select, etc.) to preview the message or notification, launch the application associated with the message or notification, dismiss the message or notification, or any other action related to the messages or notifications. The input caused by the user to cause the messages and notifications to move may include a gesture, a tap-and-hold for a specific time, or similar input. The length or duration of the input may determine how many tiles (such as tiles representing the notifications and messages) move toward the point of the input. For example, a longer duration input may cause more new notifications and messages to move toward the point of the input. During a longer-duration input, initially a new email message may be moved closer to the point of the input for a preview. Subsequently, during the input, other notifications (e.g., SMS messages, battery status indications, etc.) may move toward the point of the input. The order in which tiles (such as the tiles representing messages and notifications) may move toward the point of the input may be user configurable, predefined by the device, dependent upon usage frequency, or related to the most recent interaction.

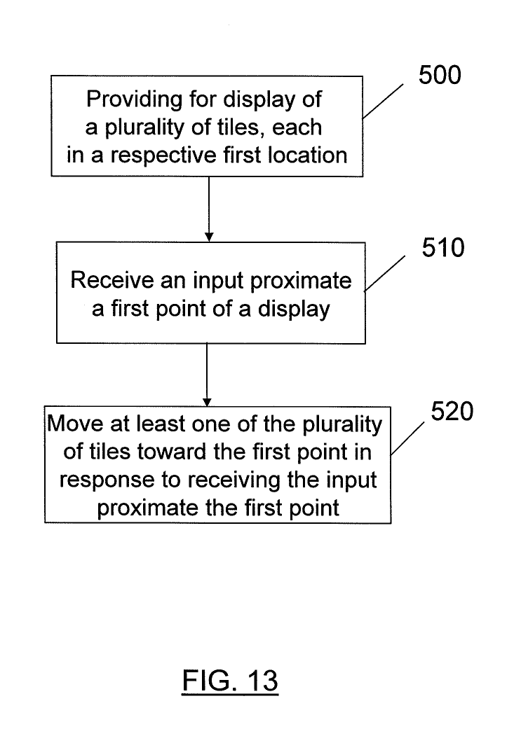

FIG. 13 is a flowchart of a method and program product according to example embodiments of the invention. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of a user device and executed by a processor in the user device. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a non-transitory computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, a method according to one embodiment of the invention, as shown in FIG. 13, may include providing for display of a plurality of tiles, each tile in a respective first location at 500. The method may also include receiving an input proximate a first point of a display, such as a touch screen display, at 510. The method may still further include moving at least one of the plurality of tiles toward the first point in response to receiving the input proximate the first point at 520.

In some embodiments, certain ones of the operations above may be modified or further amplified as described below. Moreover, in some embodiments additional optional operations may also be included. It should be appreciated that each of the modifications, optional additions or amplifications below may be included with the operations above either alone or in combination with any others among the features described herein. With reference to the method of FIG. 13, in some example embodiments, the tiles may be representations of applications, data, or information. The plurality of tiles may include tiles related to a first group and tiles related to a second group, where moving at least one tile from the plurality of tiles toward the first point includes moving the tiles related to the first group towards the first point while the tiles related to the second group remain in their respective first locations. Moving at least one of the plurality of tiles toward the first point may include moving the tiles related to the first group toward the first point and re-arranging the tiles related to the second group proximate their respective first locations. The method may include arranging the at least one of the plurality of tiles around the first point. Methods may include returning the at least one of the plurality of tiles to their respective first locations in response to a predetermined amount of time elapsing and/or in response to a second input.

In an example embodiment, an apparatus for performing the method of FIG. 13 above may comprise a processor (e.g., the processor 70) configured to perform some or each of the operations (500-520) described above. The processor 70 may, for example, be configured to perform the operations (500-520) by performing hardware implemented logical functions, executing stored instructions, or executing algorithms for performing each of the operations. Alternatively, the apparatus may comprise means for performing each of the operations described above.

An example of an apparatus according to an example embodiment may include at least one processor and at least one memory including computer program code. The at least one memory and the computer program code may be configured to, with the at least one processor, cause the apparatus to perform the operations 500-520 (with or without the modifications and amplifications described above in any combination).

An example of a computer program product according to an example embodiment may include at least one computer-readable storage medium having computer-executable program code portions stored therein. The computer-executable program code portions may include program code instructions for performing operations 500-520 (with or without the modifications and amplifications described above in any combination).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe some example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method comprising:
providing for display of a plurality of tiles, each in a respective first location;
receiving an input proximate a first point of a display; and
moving at least one of the plurality of tiles toward the first point in response to receiving the input proximate the first point.

2. A method according to claim 1, wherein the tiles comprise representations of applications, data, or information.

3. A method according to claim 1, wherein the plurality of tiles comprises tiles related to a first group and tiles related to a second group, wherein moving at least one of the plurality of tiles toward the first point comprises moving the tiles related to the first group toward the first point while the tiles related to the second group remain in their respective first locations.

4. A method according to claim 1, wherein the plurality of tiles comprises tiles related to a first group and tiles related to a second group, wherein moving at least one of the plurality of tiles toward the first point comprises moving the tiles related to the first group toward the first point and re-arranging the tiles related to the second group proximate their respective first locations.

5. A method according to claim 1, further comprising arranging the at least one of the plurality of tiles around the first point.

6. A method according to claim 1, further comprising returning the at least one of the plurality of tiles to their respective first locations in response to a predetermined amount of time elapsing.

7. A method according to claim 1, further comprising returning the at least one of the plurality of tiles to their respective first locations in response to a second input.

8. An apparatus comprising at least one processor and at least one memory including computer program code, the at least one memory and the computer program code configured to, with the at least one processor, cause the apparatus to:
provide for display of a plurality of tiles, each in a respective first location;
receive an input proximate a first point of a display; and
move at least one of the plurality of tiles toward the first point in response to receiving the input proximate the first point.

9. An apparatus according to claim 8, wherein the tiles comprise representations of applications, data, or information.

10. An apparatus according to claim 8, wherein the plurality of tiles comprises tiles related to a first group and tiles related to a second group, wherein moving at least one of the plurality of tiles toward the first point comprises moving the tiles related to the first group toward the first point while the tiles related to the second group remain in their respective first locations.

11. An apparatus according to claim 8, wherein the plurality of tiles comprises tiles related to a first group and tiles related to a second group, wherein moving at least one of the plurality of tiles toward the first point comprises moving the tiles related to the first group toward the first point and re-arranging the tiles related to the second group proximate their respective first locations.

12. An apparatus according to claim 8, wherein the apparatus is further caused to arrange the at least one of the plurality of tiles around the first point.

13. An apparatus according to claim 8, wherein the apparatus is further caused to return the at least one of the plurality of tiles to their respective first locations in response to a predetermined amount of time elapsing.

14. An apparatus according to claim 8, wherein the apparatus is further caused to return the at least one of the plurality of tiles to their respective first locations in response to a second input.

15. A computer program product comprising at least one computer-readable storage medium having computer-executable program code instructions stored therein, the computer-executable program code instructions comprising:
program code instructions for providing for display of a plurality of tiles, each in a respective first location;
program code instructions for receiving an input proximate a first point of a display; and
program code instructions for moving at least one of the plurality of tiles toward the first point in response to receiving the input proximate the first point.

16. A computer program product according to claim 15, wherein the tiles comprise representations of applications, data, or information.

17. A computer program product according to claim 15, wherein the plurality of tiles comprises tiles related to a first group and tiles related to a second group, wherein the program code instructions for moving at least one of the plurality of tiles toward the first point comprises program code instructions for moving the tiles related to the first group toward the first point while the tiles related to the second group remain in their respective first locations.

18. A computer program product according to claim 15, wherein the plurality of tiles comprises tiles related to a first group and tiles related to a second group, wherein the program code instructions for moving at least one of the plurality of tiles toward the first point comprises program code instructions for moving the tiles related to the first group toward the first point and program code instructions for re-arranging the tiles related to the second group proximate their respective first locations.

19. A computer program product according to claim 15, further comprising program code instructions for arranging the at least one of the plurality of tiles around the first point.

20. A computer program product according to claim 15, further comprising program code instructions for returning the at least one of the plurality of tiles to their respective first locations in response to a predetermined amount of time elapsing.
